(19) United States
(12) Patent Application Publication
(10) Pub. No.: US 2026/0145319 A1
(43) Pub. Date: May 28, 2026

(54) SYSTEMS AND METHODS FOR USING CROSS BELTS ON ROBOTS TO CONVEY OBJECTS

(71) Applicant: COLLABORATIVE ROBOTICS, Santa Clara, CA (US)

(72) Inventors: Charles Cook, Santa Clara, CA (US); Jon Battles, Santa Clara, CA (US); Justin Koch, Santa Clara, CA (US); Spencer Collins, Santa Clara, CA (US); Michael Lammers, Santa Clara, CA (US)

(21) Appl. No.: 19/400,425

(22) Filed: Nov. 25, 2025

Related U.S. Application Data
(60) Provisional application No. 63/724,739, filed on Nov. 25, 2024.

(51) Int. Cl. B25J 9/16; B25J 5/00; B66F 9/12; B66F 9/14; B66F 9/19

(52) U.S. Cl. CPC B25J 9/1617; B25J 5/007; B66F 9/125; B66F 9/14; B66F 9/19

(57) ABSTRACT

A robot may include a support portion and a conveyor. The conveyor may be coupled to the support portion. The conveyor may include a belt configured to interface with an object to cause the object to be positioned on or positioned off the belt. The conveyor may be configured to move along a height of the support portion to adjust a height of the belt relative to the support portion to permit the object to be positioned on or positioned off the belt at a variety of heights.

### CROSS-REFERENCE TO RELATED APPLICATION

This patent application claims the benefit of and priority to U.S. Provisional App. No. 63/724,739 filed Nov. 25, 2024, titled “SYSTEMS AND METHODS FOR USING CROSS BELTS ON A ROBOT,” which is incorporated in the present disclosure by reference in its entirety.

### FIELD

The embodiments discussed in the present disclosure are related to systems and methods for using cross belts on robots to convey objects.

### BACKGROUND

Unless otherwise indicated in the present disclosure, the materials described in the present disclosure are not prior art to the claims in the present application and are not admitted to be prior art by inclusion in this section.

Conveyor systems may convey (e.g., move) objects from one location to another. Some conveyor systems may be implemented as fixed installations that remain stationary (e.g., fixed conveyor systems) and operate in relation to fixed start locations and fixed end locations. Fixed conveyor systems may include pre-determined paths and configurations that are not easily modified. Objects may be placed onto the fixed conveyor systems and conveyed along the pre-determined paths to deliver the objects at the end locations.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more embodiments of the present disclosure may include a robot. The robot may include a support portion. The robot may also include a conveyor coupled to the support portion. The conveyor may include a belt configured to selectively interface with an object to cause the object to be positioned on or positioned off the belt. The conveyor may be configured to move along a height of the support portion to adjust a height of the belt relative to the support portion to permit the object to be positioned on or positioned off the belt at a variety of heights.

One or more embodiments of the present disclosure may include a robot. The robot may include a support portion. The robot may also include arms coupled to the support portion. The robot may include a conveyor including one or more attachment points configured to receive corresponding mating elements of the arms to couple the conveyor to the arms. The conveyor may include an internal drive mechanism configured to, when the conveyor is attached to the arms, interface with an object to move the object along a length of the conveyor.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example operational environment in which a robot may operate;

FIG. 2 illustrates an example of the robot of FIG. 1;

FIG. 3 illustrates another example of the robot of FIG. 1;

FIGS. 4A-4G illustrate example configurations of the robot of FIG. 2 with a conveyor and/or an arm assembly at different positions and/or arrangements relative to a support portion;

FIGS. 5A-5D illustrates various example positions of the conveyor of the robot of FIG. 2 relative to an axis of the support portion;

FIGS. 6A-6C illustrate example conveyor systems that are formed by multiple instances of the robot of FIG. 2; and

FIG. 7 illustrates an example computing system that may be used with the robot of FIG. 1,

all according to at least one embodiment described in the present disclosure.

### DETAILED DESCRIPTION

Conveyor systems may convey objects from one location to another location within various industrial environments including warehouses, distribution centers, manufacturing facilities, and sorting operations. The conveyor systems may reduce manual labor by conveying the objects rather than operators conveying the objects. Some conveyor systems may also sort the objects. For example, a conveyor system may sort the objects based an object type or target end locations.

Some conveyor systems include fixed installations that remain stationary (e.g., fixed conveyor systems) and operate in relation to fixed start locations and fixed end locations. Fixed conveyor systems may have limited abilities to operate in dynamic environments. The fixed conveyor system may have limited abilities to operate with operators, objects, start locations, or end locations that move or change. For example, the fixed conveyor systems may not be able to receive objects from start locations (e.g., vehicles, operators, or carts) that move to different locations. As another example, the fixed conveyor systems may not be able to provide objects to end locations (e.g., vehicles, operators, carts, or bins) that move to different locations.

The fixed conveyor systems may have limited abilities to provide the objects to end locations that include different types. For example, the fixed conveyor systems may be configured to provide the objects to only a single type of end location (e.g., one type of vehicle or one type of bin). As another example, the fixed conveyor systems may be incompatible with different types of end locations (e.g., compatible with only type of bin and not compatible with vehicles or other types of bins).

The fixed conveyor system may present challenges when conveying or sorting operations are to be established in new environment either temporarily or quickly. For example, the fixed conveyor systems may take a significant amount of time to install and disassemble. Accordingly, installing the fixed conveyor systems may be time prohibitive in new environment.

Some conveyor systems may be unable to convey (e.g., offload) the objects into vehicles, bins, containers, or other end locations that cannot be positioned proximate to the conveyor system. For example, the pre-determined paths of these conveyor systems may include fixed end locations and the vehicles or other targeted end locations may be prevented (e.g., blocked) from being positioned at the fixed end locations. Likewise, these conveyor systems may be unable to receive objects from vehicles, bins, or other start locations that cannot be positioned proximate to the conveyor system.

Therefore, there is a need for an adaptable way to convey objects that allows conveyor systems to operate in dynamic or changing environments.

A robot in accordance with embodiments described in the present disclosure may include a conveyor to interface with objects to sort or convey the objects within changing or dynamic environments. The conveyor may be configured to receive and offload an object on a left side and/or a right side of the conveyor. In addition, the robot may move the conveyor along a height of the robot to match or align to heights of different start locations or end locations. Further, the robot may pivot (e.g., rotate) the conveyor around an axis to adjust an orientation of the conveyor to match or align to different start locations or end locations. The robot may move within the environment to position itself relative to start locations or end locations that change. In addition, the robot may position itself relative to other robots to form a conveyor system to convey objects.

Therefore, the robot described in the present disclosure may adapt to dynamic environments or form part of a conveyor system to adapt to dynamic environments.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

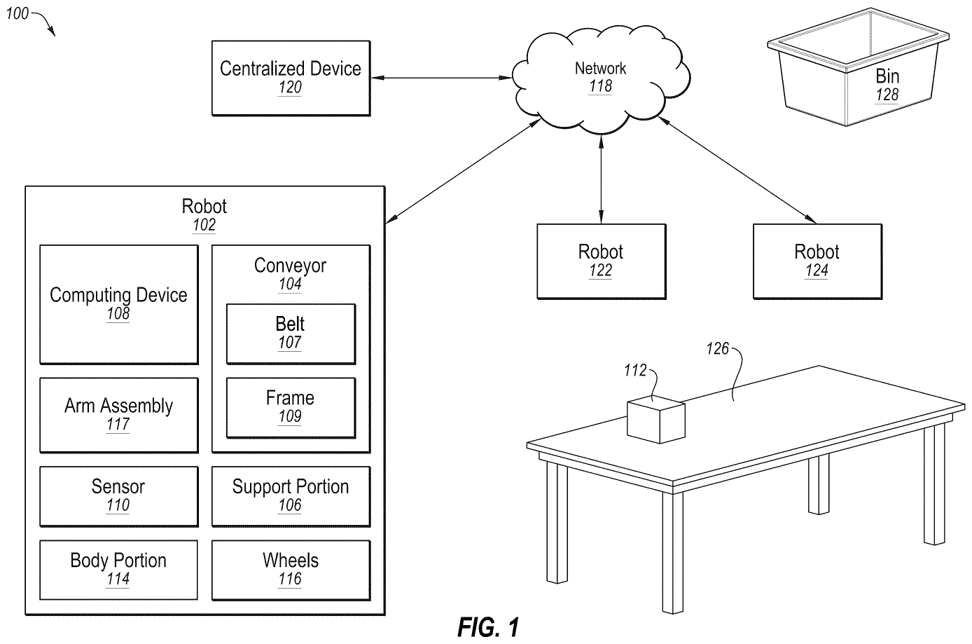

FIG. 1 illustrates a block diagram of an example operational environment 100 in which a robot 102 may operate, in accordance with at least one embodiment described in the present disclosure. The environment 100 may include any location in which the robot 102 may operate. For example, the environment 100 may include a warehouse, a hospital, a campus, a building, a field, a construction site, and the like.

The environment 100 may include various elements that facilitate the operation of the robot 102. For example, the environment 100 may include an object 112 positioned on a table 126. The object 112 is shown in FIG. 1 as a box for example purposes. The object 112 may include any appropriate object such as a container, a storage tote, a package, or a bin. The environment 100 may also include a bin 128 that is configured to receive the object 112.

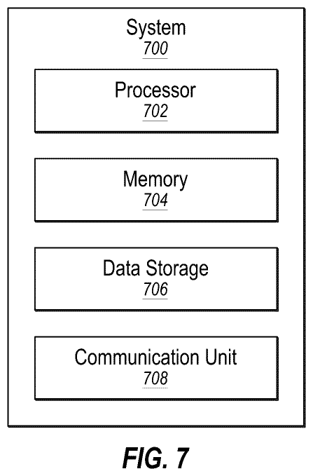

The robot 102 may include a conveyor 104 and/or an arm assembly 117 configured to engage with the object 112. As described in more detail below, the robot 102 may include a computing device 108 that causes the conveyor 104 and/or the arm assembly 117 to move relative to the support portion 106. An example of such a computing system is described below with reference to FIG. 7.

The computing device 108 may cause the conveyor 104 and/or the arm assembly 117 to move along a height of the support portion 106 to permit the object 112 to be positioned on or off the conveyor 104 at a variety of heights. The computing device 108 may cause the arm assembly 117 to retain the object 112, while the robot 102 traverses the environment 100 to allow the object 112 to be moved within the environment 100. Additionally or alternatively, as described in more detail below, the conveyor 104 may be used as part of a conveyor system to move the object 112 from a start location (e.g., the table 126 or the bin 128) to an end location (e.g., the bin 128 or the table 126).

The conveyor 104 may include a belt 107 that is coupled or otherwise connected to a frame 109. The belt 107 may rotate and while rotating, interface with the object 112 and position the object 112 on or off the conveyor 104. Additionally or alternatively, the arm assembly 117 may interface with the object 112 to position the object 112 on or off the conveyor 104. As discussed in more detail below, the computing device 108 may cause the belt 107 to rotate to move the object 112 along a length of the conveyor 104. The frame 109 may maintain a shape of the belt 107 and support the object 112 when positioned on the belt 107.

The robot 102 may include a body portion 114 coupled to the support portion 106. In addition, the body portion 114 may be coupled to one or more wheels 116. The computing device 108 may cause the robot 102 to drive the wheels 116 to move and position the robot 102 within the environment 100. The computing device 108 may cause the robot 102 to drive the wheels 116 to position the robot 102 relative to other robots 122, 124 or to align the conveyor 104 relative to the object 112, a surface on to which the object 112 is to be positioned on to or off from, or another conveyor to form a conveyor system. The wheels 116 may include omni-directional wheels. Accordingly, the robot 102 may operate as part of a mobile conveyor system.

The robot 102 may include a sensor 110 that captures sensor data. The sensor 110 may include a camera, a video camera, a light detection and ranging (LIDAR) sensor, an infrared sensor, a radar sensor, an ultrasonic sensor, a proximity sensor, a force sensor, a torque sensor, an accelerometer, a gyroscope, a magnetometer, a temperature sensor, a pressure sensor, a weight sensor, a load cell, a strain gauge, a photoelectric sensor, a laser sensor, an optical encoder, a position sensor, a displacement sensor, a global positioning system sensor, a radio frequency identification sensor, a near field communication sensor, a barcode scanner, a quick response code scanner, or any other appropriate sensor configured to capture the sensor data representative of the environment 100, the robot 102, the robots 122, 124, the object 112, or any combination thereof.

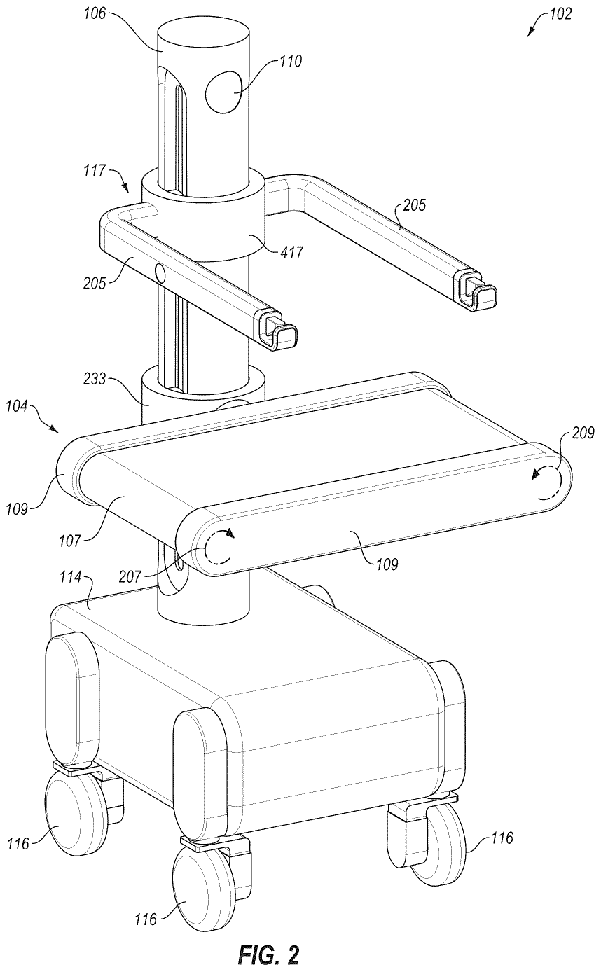

The sensor 110 may be positioned at various locations on the robot 102 to capture the sensor data from different perspectives. For example, the sensor 110 may be mounted on the conveyor 104 to capture sensor data representative of the object 112 when positioned on the conveyor 104 and/or the conveyor 104. Additionally or alternatively, the sensor 110 may be mounted on the support portion 106 to capture sensor data representative of the environment 100 around the robot 102 and/or the object 112 when on the conveyor 104. The sensor 110 may also be mounted on the body portion 114 to capture sensor data representative of surfaces or obstacles in the environment 100 during movement of the robot 102. The robot 102 may include multiple instances of the sensor 110 positioned at different locations on the robot 102. The sensor is shown in FIGS. 2-6C on the support portion 106 for example purposes.

The sensor data may be representative of various aspects of the object 112, the robot 102, the environment 100, or some combination thereof. For example, the sensor data may be representative of a position of the object 112 on the conveyor 104, a size of the object 112, one or more dimensions of the object 112, a speed of the object 112 relative to the conveyor 104, a number of items within the object 112, a label of the object 112, a state of the object 112, a position of the object 112 on a surface, or a state of the conveyor 104. The number of items within the object 112 may indicate a number of individual items or parts that are located within the object 112 (e.g., a box, a storage tote, or any other appropriate container). The state of the conveyor 104 may indicate a wear state of the belt 107 (e.g., breaks in or damage to the belt 107) or a position of the belt 107 relative to the frame 109 (e.g., centering of the belt 107 relative to the frame 109).

The sensor data may permit the computing device 108 to determine if the object 112 is on the conveyor 104, identify the object 112 when it is on the conveyor 104, or determine the position of the object 112 on the conveyor 104. Based on this information, the computing device 108 can control operations of the robot 102 to prevent the object 112 from unintentionally falling off the conveyor 104. For example, the computing device 108 may cause the robot 102 to move the arm assembly 117 to interface with the object 112 while on the conveyor 104. As another example, the computing device 108 may analyze the sensor data and determine that the object 112 includes a round shape and cause the robot 102 to move the arm assembly 117 to interface with the object 112 and prevent the object 112 from unintentionally falling off (e.g., rolling off) the conveyor 104.

The computing device 108 may cause the conveyor 104 and/or the arm assembly 117 to position the object 112 on or off the belt 107 while the robot 102 is moving. For example, the computing device 108, using the sensor data, may determine a speed at which the robot 102 should pass an external conveyor system or surface and a speed and direction at which to rotate the belt 107 to receive the object 112 without the robot 102, the external conveyor system, or both stopping. As another example, the computing device 108, using the sensor data, may determine a speed at which the robot 102 should pass an external conveyor system or surface and a speed at which to rotate the belt 107 to offload the object 112 without the robot 102 stopping.

The computing device 108, using the sensor data, may inspect the object 112 to determine where to offload the object 112. For example, the computing device 108 may determine, using the sensor data, that the object 112 came from the table 126 and should be offloaded to the bin 128. Additionally or alternatively, the computing device 108, based on the sensor data, may inspect the object 112 to determine if it is damaged or has any other defect. If the object 112 is damaged or has a defect, the computing device 108 may determine that the object 112 is to be put in a particular bin or location for damaged objects and may navigate and control the conveyor 104 to place the object 112 in the particular bin or location.

The computing device 108 may determine, using the sensor data, towards which side of the conveyor 104 the object 112 is to be offloaded. The computing device 108 may cause the conveyor 104 to position the object 112 on the conveyor 104 closer to the side towards which the object 112 is to be offloaded to the reduce an amount of time to offload the object 112. For example, the computing device 108 may determine that the object 112 is to be offloaded towards a right side of the conveyor 104 and the computing device 108 may cause the conveyor 104 and/or the arm assembly 117 to position the object 112 closer to the right side.

The environment 100 may include a network 118. The network 118 may include any communication network configured for communication of signals between the robot 102 and the other components of the environment 100 (e.g., the robots 122, 124 or a centralized device 120). The network 118 may be wired or wireless. The network 118 may have numerous configurations including a star configuration, a token ring configuration, or another suitable configuration. Furthermore, the network 118 may include a local area network (LAN), a wide area network (WAN) (e.g., the Internet), and/or other interconnected data paths across which multiple devices may communicate. In some embodiments, the network 118 may include a peer-to-peer network. The network 118 may also be coupled to or include portions of a telecommunications network that may enable communication of data in a variety of different communication protocols.

In some embodiments, the network 118 includes or is configured to include a BLUETOOTH® communication network, a Z-Wave® communication network, an Insteon® communication network, an EnOcean® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 118 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the other components (e.g., 102, 120, 122, or 124) of the environment 100.

The environment 100 may include the centralized device 120. The centralized device 120 may monitor the environment 100 and provide instructions to the robot 102, the robots 122, 124, or some combination thereof. The centralized device 120 may include any appropriate computing system and may be the same as or similar to the computing device 108 and an example of such a computing system is described below with reference to FIG. 7. The robots 122, 124 may be the same or similar to the robot 102. For example, the robots 122, 124 may include conveyors (not shown) that are configured to interface with the object 112 to move it within the environment 100.

The centralized device 120 may determine when the robots 102, 122, 124 or any combination thereof should form a conveyor system. As described in more detail below, the conveyor system may be configured to move the object 112 from the start location (e.g., the table 126 or the bin 128) to the end location (e.g., the bin 128 or the table 126). The centralized device 120 may send instructions to the robots 102, 122, 124 or any combination thereof to move and align themselves relative to each other, the start location, and/or the end location to form a path for the object 112. The robots 102, 122, 124 may convey (e.g., move) the object 112 from the start location to the end location using the conveyors 104 of the robots 102, 122, 124.

Therefore, the robot 102, the robots 122, 124, or some combination thereof may adapt to dynamic environments or form part of a conveyor system to adapt to dynamic environments.

FIG. 2 illustrates an example of the robot 102 of FIG. 1, in accordance with at least one embodiment described in the present disclosure.

The conveyor 104 may include drive motors (not shown) that cause the belt 107 to rotate. The belt 107 may rotate in various directions to position an object (e.g., the object 112 of FIG. 1) on or off the belt 107, move the object along the length of the conveyor 104 (e.g., from a right side to a left side or from a left side to a right side), or both. For example, the belt 107 may rotate in a clockwise direction (represented by arrow 207) to position or move the object on the belt 107 from the right side of the conveyor 104 and/or to position the object off the belt 107 to the left side of the conveyor 104. As another example, the belt 107 may rotate in a counterclockwise direction (represented by arrow 209) to position or move the object on the belt 107 from the left side of the conveyor 104 and/or to position the object off the belt 107 to the right side of the conveyor 104.

The conveyor 104 may include an interface portion 233 that is coupled to the frame 109 and to the support portion 106. The interface portion 233 may be coupled to the support portion 106 to move along a height of the support portion 106. The support portion 106 may include an actuator (not shown) configured to move the interface portion 233 along the height of the support portion 106 (e.g., raise or lower the conveyor 104). The actuator may include a rack and pinion system, a lead mechanism system, a ball mechanism system, a belt mechanism system, a cable driver mechanism system, or any other appropriate actuator system.

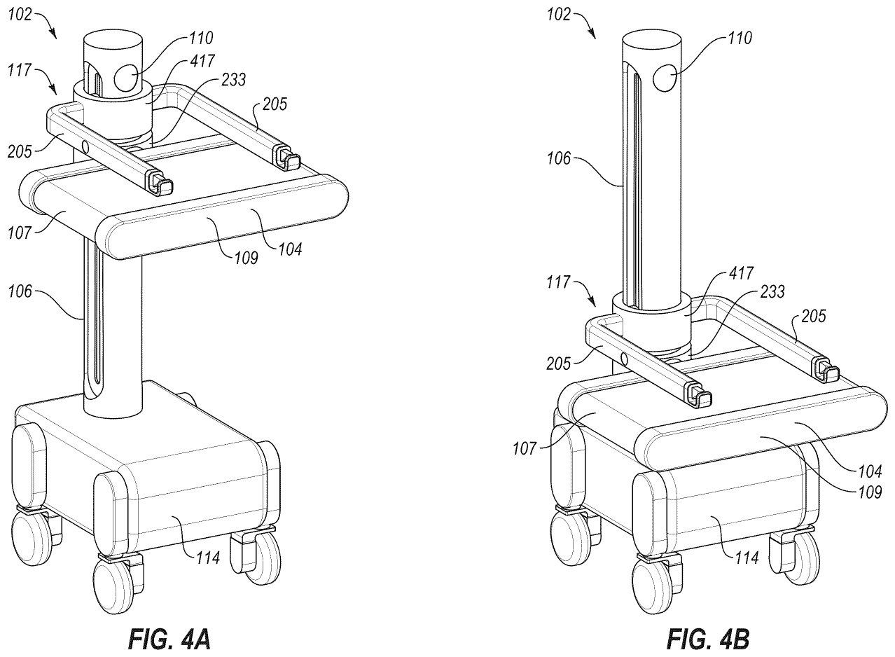

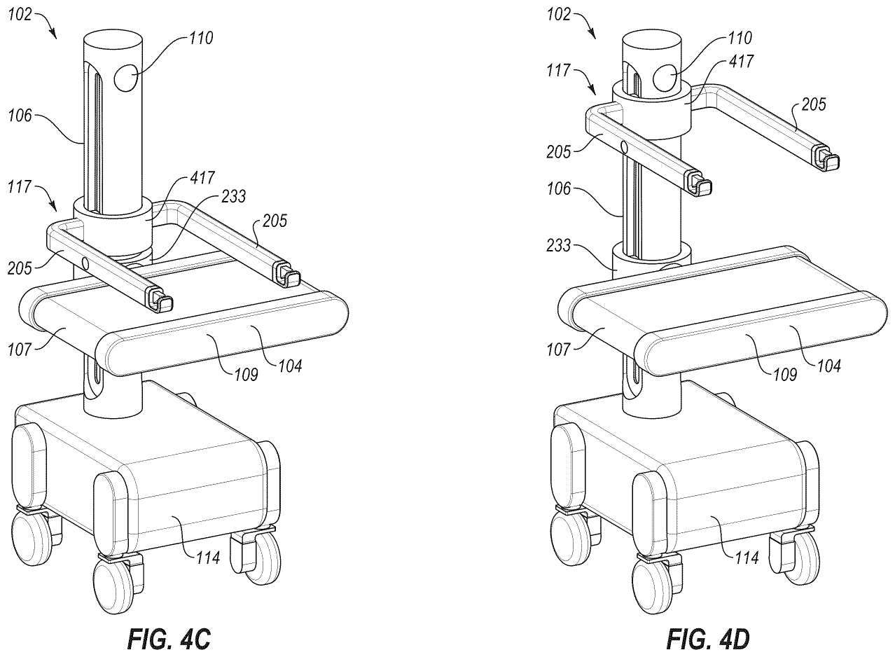

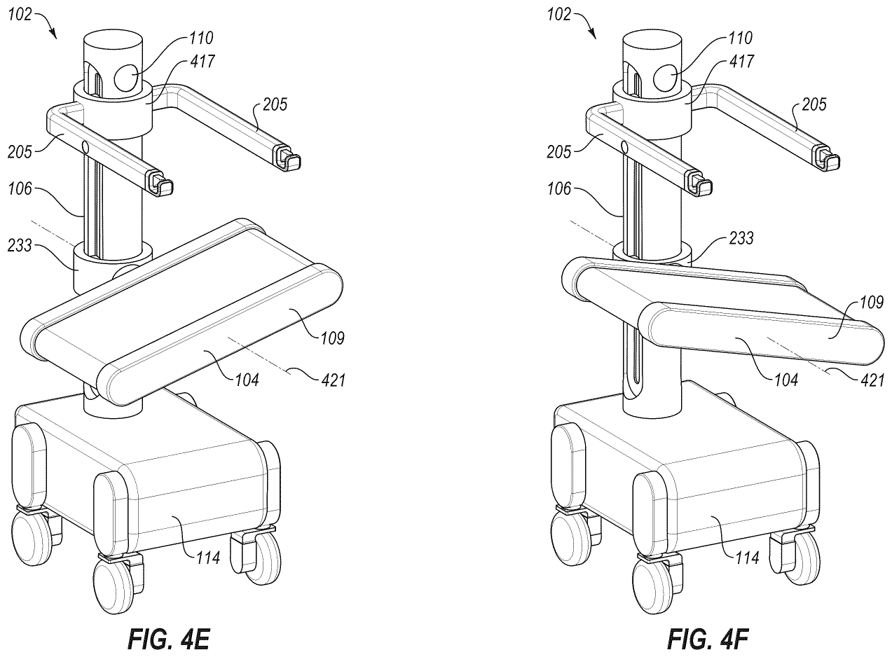

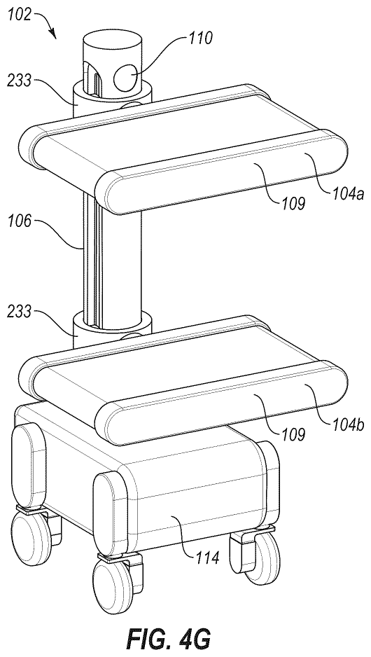

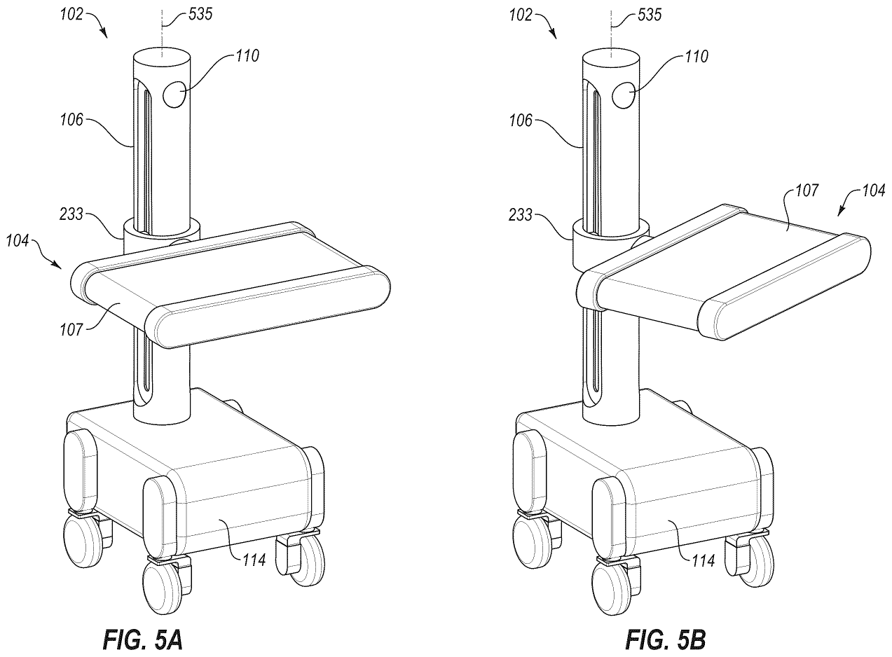

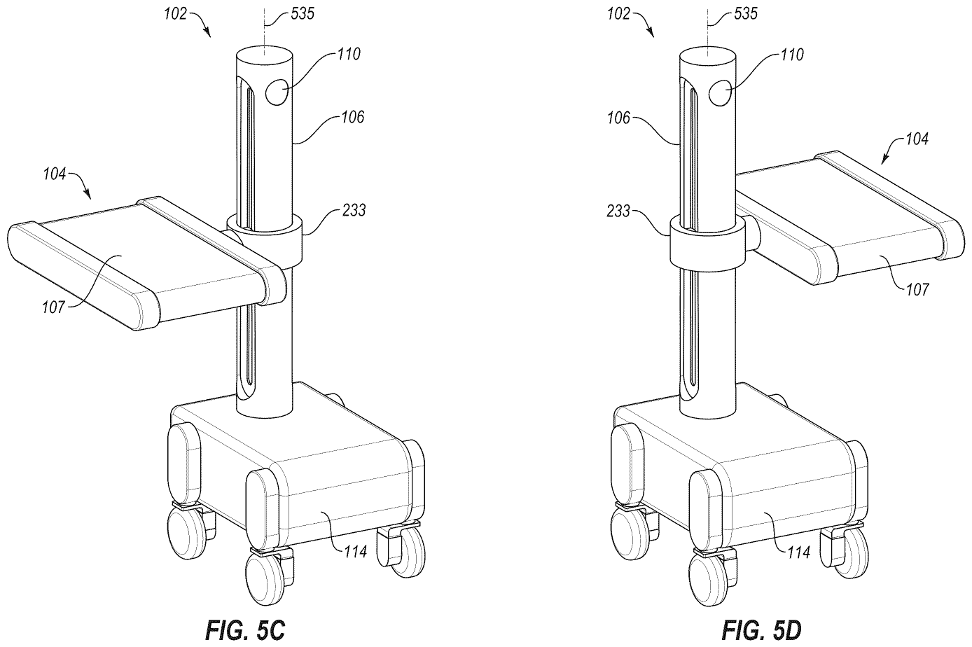

The interface portion 233 may move along the height of the support portion 106 to adjust a height of the conveyor 104 (e.g., the belt 107) relative to the support portion 106 and position an object on or off the conveyor 104 at a variety of heights. Additionally or alternatively, as described in more detail below in relation to FIGS. 4C and 4D and FIGS. 5A-5D, the interface portion 233 may be coupled to the support portion 106 to pivot around an axis of the conveyor 104 to change a slope of the conveyor 104, rotate relative to an axis of the support portion 106, or both.

The conveyor 104 is illustrated in FIG. 2 as including the belt 107 for example purposes. Additionally or alternatively, the conveyor 104 may include internal drive rollers that are configured to position an object on or off the conveyor 104. In these and other embodiments, the conveyor 104 may include one or more internal roller motors configured to cause the internal drive rollers to rotate.

As described in more detail below, the arm assembly 117 may include a connection portion 417 that is coupled to the support portion 106 to move along the height of the support portion 106. The connection portion 417 may move along the height of the support portion 106 to adjust a height of the arm assembly 117 relative to the body portion 114, the conveyor 104, or both. The arm assembly 117 may move to a raised position to permit an object to be positioned on or off the conveyor 104. The arm assembly 117 may move to a lowered position to prevent an object from unintentionally falling off the conveyor 104, to prevent an object from being positioned on the conveyor 104, or both.

The arm assembly 117 may include manipulators to interact with objects. For example, as shown in FIG. 2, the arm assembly 117 can include grippers to grab a box or a handle of a cart. As another example, the arm assembly 117 can use bimanual manipulation to move (e.g., rotate or twist) objects while on the conveyor 104. As yet another example, the arm assembly 117 may include manipulators configured to engage with objects and hold them steady while the robot 102 is moving.

As shown in FIG. 2, the sensor 110 may be connected to the support portion 106. However, as discussed above, the sensor 110 may be connected to and/or positioned anywhere on the robot 102 to capture the sensor data.

With reference to FIGS. 1 and 2, an example of the robot 102 conveying the object 112 from the table 126 to the bin 128 will now be described. To position the object 112 on the conveyor 104, the computing device 108 may cause the arm assembly 117 to move to the raised position (described in more detail below) relative to the conveyor 104. The computing device 108 may adjust a height of the conveyor 104 to correspond to a height of the object 112 or the table 126.

The computing device 108 may cause the belt 107 to rotate in a corresponding direction to move the object 112 from the table 126 on to the conveyor 104. In some embodiments, an operator or the arm assembly 117 may push the object 112 until it interfaces with the belt 107. In other embodiments, the computing device 108 may cause the arm assembly 117 to interface with the object 112 (e.g., grab the object 112) and position the object 112 on the belt 107.

When the object 112 is on the conveyor 104, the computing device 108 may cause the arm assembly 117 to move to the lowered position (described in more detail below) relative to the conveyor 104 to prevent the object 112 from falling off the conveyor 104. The computing device 108 may cause the robot 102 to drive the wheels 116 to move towards the bin 128 with the arm assembly 117 in the lowered position.

When the robot 102 is aligned with the bin 128, the computing device 108 may cause the arm assembly 117 to move to the raised position relative to the conveyor 104, cause the conveyor 104 to move to a height that corresponds to a height of the bin 128, or both. The computing device 108 may cause the belt 107 to rotate in a corresponding direction to move the object 112 from the conveyor 104 and into the bin 128. In some embodiments, the arm assembly 117 may move the object 112 from the conveyor into the bin 128.

The arm assembly 117 may sort items in the object 112 while traversing the environment 100. The arm assembly 117 may include multiple degrees of freedom to access an internal volume of the object 112 and sort or manipulate the items therein.

The arm assembly 117 may include arms 205 that extend beyond an edge of the conveyor 104. The arms 205 may extend beyond the edge of the conveyor 104 to permit the arms 205 (e.g., effectors of the arms 205) to interface with a handle of a container (e.g., the bin 128 or other object). The arm assembly 117 may be configured to engage with the bin 128 (e.g., a container) and transfer objects from the bin 128 to the conveyor 104.

The robot 102 is shown in FIG. 2 as including the arm assembly 117 for example purposes. The arm assembly 117 may be omitted and the conveyor 104 may operate without assistance or support from the arm assembly 117.

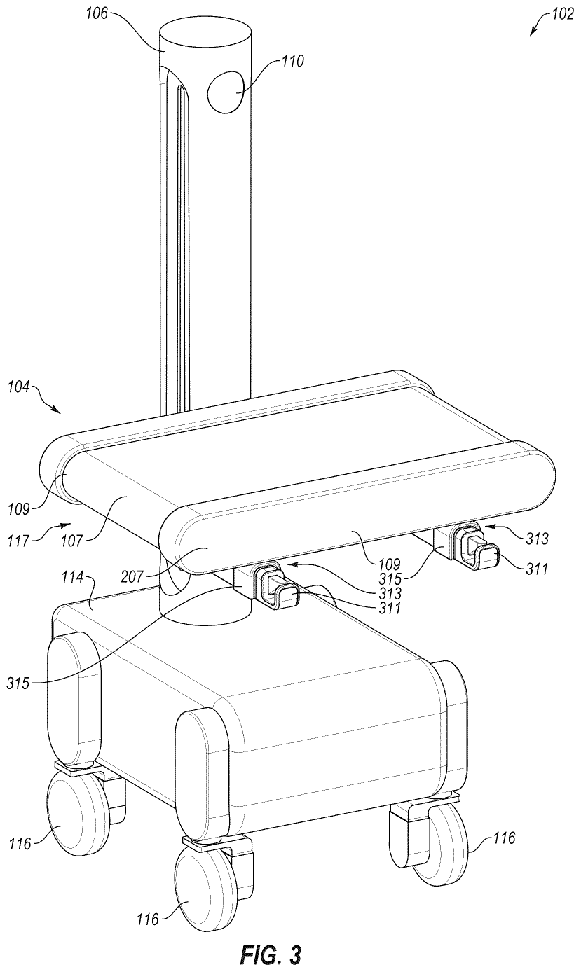

FIG. 3 illustrates another example of the robot 102 of FIG. 1, in accordance with at least one embodiment described in the present disclosure.

The arm assembly 117 may include arms 311 that are coupled to the support portion 106. The arms 311 may include one or more attachment points 313. The conveyor 104 may include one or more mating elements 315. The frame 109 may include the mating elements 315. The attachments points 313 may attach or connect to the mating elements 315 to couple the conveyor 104 to the arms 311. For example the mating elements 315 may receive portions the attachment points 313 of the arms 311 to couple the conveyor 104 to the arms 311. The attachment points 313 and the mating elements 315 may form a quick-release latch, a sliding rail interface, or a clamp mechanism. In some embodiments, the conveyor 104 be placed on or rest on the arms 311 without coupling to the arms 311.

The conveyor 104 may include the drive motors (not shown) that cause the belt 107 to rotate to position an object (e.g., the object 112 of FIG. 1) on or off the belt 107 or move the object along the length of the conveyor 104 as described above.

The arm assembly 117 may be coupled to the support portion 106 to move along a height of the support portion 106. For example, the arm assembly 117 may include a connection portion (not shown) that is coupled to the arms 311 and the support portion 106. The support portion 106 may include an actuator (not shown) configured to move the connection portion along the height of the support portion 106 (e.g., raise or lower the arm assembly 117). The actuator may include a rack and pinion system, a lead mechanism system, a ball mechanism system, a belt mechanism system, a cable driver mechanism system, or any other appropriate actuator system.

The connection portion may move along the height of the support portion 106 to adjust a height of the conveyor 104 (e.g., the belt 107) relative to the support portion 106 and position objects on and off the conveyor 104 at a variety of heights. Additionally or alternatively, the connection portion may be coupled to the support portion 106 to pivot around an axis of the conveyor 104 to change a slope of the conveyor 104, rotate relative to an axis of the support portion 106, or both in ways that are similar to what is described below in relation to the conveyor 104 of FIG. 2.

The conveyor 104 is illustrated in FIG. 3 as including the belt 107 for example purposes. Additionally or alternatively, the conveyor 104 may include internal drive rollers that are configured to position the object on or off the conveyor 104. In these and other embodiments, the conveyor 104 may include one or more internal roller motors configured to cause the internal drive rollers to rotate.

As shown in FIG. 3, the sensor 110 may be connected to the support portion 106. However, as discussed above, the sensor 110 may be connected to and/or positioned anywhere on the robot 102 to capture the sensor data.

When the conveyor 104 is coupled to or placed on the arms 311, the arms 311 may extend beyond an edge of the conveyor 104. The arms 311 may extend beyond the edge of the conveyor 104 to permit the arms 311 (e.g., effectors of the arms 311) to interface with a handle of a container (e.g., the bin 128 or other object). Alternatively, the conveyor 104 may be removed (e.g., detach) to permit the arms 311 to operate independent of the conveyor 104. For example, the conveyor 104 may be removed to permit the arms 311 to interface with an object using the effectors.

In some embodiments, the robot 102 may include an additional arm assembly that operates the same as or similar to the arm assembly 117 as described in relation to FIGS. 1 and 2.

With reference to FIGS. 1 and 3, an example of the robot 102 conveying the object 112 from the table 126 to the bin 128 will now be described. To position the object 112 on the conveyor 104, the computing device 108 may cause the arm assembly 117 to move to adjust a height of the conveyor 104 to correspond to a height of the object 112 or the table 126.

The computing device 108 may cause the belt 107 to rotate in a corresponding direction to move the object 112 from the table 126 on to the conveyor 104. For example, the mating elements 315 may couple to the attachment points 313 such that command signals from the computing device 108 may be provided to the conveyor 104 the mating elements 315 and the attachment points 313. Alternatively, the computing device 018 may provide the command signals to the conveyor 104 wirelessly. In some embodiments, an operator may push the object 112 until it interfaces with the belt 107. The computing device 108 may cause the robot 102 to drive the wheels 116 to move towards the bin 128.

The computing device 108 may cause the arm assembly 117 to move to adjust the height of the conveyor 104 to correspond to a height of the bin 128. When the robot 102 is aligned with the bin 128, the computing device 108 may cause the belt 107 to rotate in a corresponding direction to move the object 112 from the conveyor 104 and into the bin 128.

Referring to FIGS. 2 and 3, the arms 205 or 311 may include different effectors than what is shown. For example, the effectors may include vacuum effectors, suction cup effectors, or any other appropriate effector.

FIGS. 4A-4G illustrate example configurations of the robot 102 of FIG. 2 with the conveyor 104 and/or the arm assembly 117 at different positions and/or arrangements relative to the support portion 106, in accordance with at least one embodiment described in the present disclosure. FIGS. 4A-4G shows various views of the robot 102.

As shown in FIG. 4A, the interface portion 233 may move along the height of the support portion 106 to position the conveyor 104 in a raised position. In addition, as shown in FIG. 4B, the interface portion 233 may move along the height of the support portion 106 to position the conveyor 104 in a lowered position. In the raised position, the conveyor 104 may position an object on or off the conveyor 104 at a higher height than at the lowered position. Additionally, in the lowered position, the conveyor 104 may position an object on or off the conveyor 104 at a lower height than at the raised position. The ability of the interface portion 233 to move along the height of the support portion 106 may permit the conveyor 104 to be aligned with external surfaces of different heights without using external ramps or other devices to lift the robot 102 or the object.

Although illustrated at only two example heights in FIGS. 4A and 4B, the conveyor 104 may be positioned at any appropriate height between the raised position and the lowered position. Additionally, the arm assembly 117 is shown in FIGS. 4A and 4B as being in a lowered position relative to the conveyor 104 to prevent an object from unintentionally falling off the conveyor 104. The connection portion 417, as described in more detail below, may also move along a height of the support portion 106 to move the arm assembly 117 between a raised position relative to the conveyor 104 and the lowered position relative to the conveyor 104 to permit an object to be positioned on or off the conveyor 104 or to prevent an object from unintentionally falling off.

As shown in FIG. 4C, the connection portion 417 may move along the height of the support portion 106 to move the arm assembly 117 (e.g., the arms 205) to the lowered position relative to the conveyor 104. In the lowered position relative to the conveyor 104, a distance between the arms 205 and the conveyor 104 may be sized to prevent an object from unintentionally falling off the conveyor 104. For example, the distance between the arms 205 and the conveyor 104 may be smaller than a height of the object.

As shown in FIG. 4D, the connection portion 417 may move along the height of the support portion 106 to move the arm assembly 117 (e.g., the arms 205) to the raised position relative to the conveyor 104. In the raised position relative to the conveyor 104, the distance between the arms 205 and the conveyor 104 may be sized to permit an object to be positioned on or off the conveyor 104. For example, the distance between the arms 205 and the conveyor 104 may be greater than the height of the object.

Instead of or in addition to the connection portion 417 moving the arm assembly 117, the interface portion 233 may move along the height of the support portion 106 to position the arm assembly 117 in the lowered position relative to the conveyor 104 or the raised position relative to the conveyor 104.

The connection portion 417, the interface portion 233, or both may be coupled to the support portion 106 via a rotational joint that permits angular adjustment. The rotational joint may include a pivot mechanism with a locking mechanism to secure the interface portion 233 at a desired rotational angle. The rotational joint may include ball bearings, roller bearings, or sleave bearings; a ring gear; a pinion gear, a chain drive system, a belt driver system, or any other appropriate methodology.

As shown in FIGS. 4E and 4F, the interface portion 233 may be configured to pivot around an axis 421 of the conveyor 104 to adjust an angle of the belt 107 relative to a ground surface (not shown). As shown in FIG. 4E, the interface portion 233 may pivot around the axis 421 to lower the right side of the conveyor 104 and raise the left side of the conveyor 104. In addition, as shown in FIG. 4F, the interface portion 233 may pivot around the axis 421 to lower the left side of the conveyor 104 and raise the right side of the conveyor 104.

The interface portion 233 may pivot around the axis 421 to adjust a slope of the belt 107 to permit the conveyor 104 to convey an object from a lower surface to a higher surface. For example, in FIG. 4E, the conveyor 104 may receive an object from the lower surface on the right side and offload the object to the higher surface on the left side. As another example, in FIG. 4F, the conveyor 104 may receive the object from the higher surface on the left side and offload the object to the lower surface on the right side.

FIG. 4G illustrates an embodiment of the robot 102 in which the support portion 106 is coupled to two conveyors 104a-b. The two conveyors 104a-b may permit the robot 102 to interface with multiple objects at the same time. For example, the conveyor 104a may interface with a first object while the conveyor 104b interfaces with a second object. The conveyors 104a-b may permit the robot 102 to receive and convey multiple objects to or from different locations. The robot 102 is illustrated in FIG. 4G as including two conveyors 104a-b coupled to the support portion 106 for example purposes. However, any number of conveyors may be coupled to the support portion 106. For example, one, three, four, five, or more conveyors may be coupled to the support portion 106.

The robot 102 is illustrated in FIG. 4G without the arm assembly 117 for ease of illustration. The robot 102 may include the arm assembly 117 or any appropriate number of the arm assembly 117 that operate in relation to the multiple conveyors 104a-b as described in relation to the arm assembly 117.

The connection portion, the arm assembly 117, or both of the example robot 102 shown in FIG. 3 may perform similar operations as the interface portion 233 of the conveyor 104 described in FIGS. 4A-4G. The connection portion, the arm assembly 117, or both of the robot 102 shown in FIG. 3 may move along the height of the support portion 106 to position the conveyor 104 at various heights in a similar manner as described above in relation to the conveyor 104 in FIGS. 4A-4D. The connection portion, the arm assembly 117, or both of the robot 102 shown in FIG. 3 may also pivot around an axis to adjust an angle of the conveyor 104 relative to a ground surface in a similar manner as described above in relation to the conveyor 104 in FIGS. 4E and 4F. The robot 102 shown in FIG. 3 may include multiple arm assemblies and conveyors to convey multiple objects in a similar manner as described above in relation to the conveyors 104a-b in FIG. 4G.

FIGS. 5A-5D illustrate various example positions of the conveyor 104 of the robot 102 of FIG. 2 relative to an axis 535 of the support portion 106, in accordance with at least one embodiment described in the present disclosure. The interface portion 233 may pivot around the axis 535 to adjust an orientation of the conveyor 104 relative to the support portion 106.

The interface portion 233 may be coupled to the support portion 106 to permit the conveyor 104 to pivot around the axis 535. The orientation of the conveyor 104 may be adjusted to align the conveyor 104 with other devices or surfaces without having to move the entire robot 102. The interface portion 233 may pivot around the axis 535 while the support portion 106 or the rest of robot 102 is stationary. The interface portion 233 may pivot around the axis 535 while the robot 102 also rotates (e.g., the robot 102 moves or pivots around another axis). The interface portion 233 may pivot around the axis 535 in the same or opposite direction as the robot 102 (e.g., both may rotate in the clockwise direction or one may rotate in the clockwise direction while the other rotates in the counterclockwise direction).

As shown in FIG. 5A, the conveyor 104 may be in a default position relative to the support portion 106. The default position of the conveyor 104 may be generally positioned above the body portion 114. The default position may correspond to the position of the conveyor 104 shown in FIG. 2. In addition, as shown in FIG. 5B, the interface portion 233 may pivot around the axis 535 in a counterclockwise direction to orient the conveyor 104 in a position offset from the default position. As shown in FIGS. 5C and 5D, the interface portion 233 may pivot around the axis 535 in a clockwise direction (e.g., the position shown in FIG. 5C) or a counterclockwise direction (e.g., the position shown in FIG. 5D) such that the conveyor 104 is offset from the default position by negative ninety degrees or positive ninety degrees. Although illustrated at four positions in FIGS. 5A-5D, the interface portion 233 may pivot around the axis 535 to orient the conveyor 104 at any appropriate position relative to the support portion 106.

The connection portion, the arm assembly 117, or both of the robot 102 shown in FIG. 3 may perform similar operations as the interface portion 233 of the conveyor 104 described in FIGS. 5A-5D. The connection portion, the arm assembly 117, or both of the robot 102 shown in FIG. 3 may rotate relative to an axis of the support portion 106 to adjust a position of the conveyor 104 relative to the support portion 106 in a similar manner as described above in relation to the conveyor 104 in FIGS. 5A-5D.

The connection portion 417, the interface portion 233, or both may rotate around the support portion 106 to sort objects. The conveyor 104 may receive an object when at one orientation and then rotate to offload the object at another orientation. For example, the conveyor 104 may receive an object when in the default position from a first conveyor system, another robot, a surface, or any other appropriate location and the connection portion 417 may rotate around the support portion 106 to the position shown in FIG. 5C to offload the object to a second conveyor system, another robot, another surface, or any other appropriate location.

The connection portion 417, the interface portion 233, or both may rotate around the support portion 106 using various methodologies. The connection portion 417 may be coupled to the support portion 106 via a rotational bearing assembly includes ball bearings, roller bearings, or sleeve bearings; a ring gear; a pinion gear, a belt drive system, a chain driver system, or any other appropriate methodology.

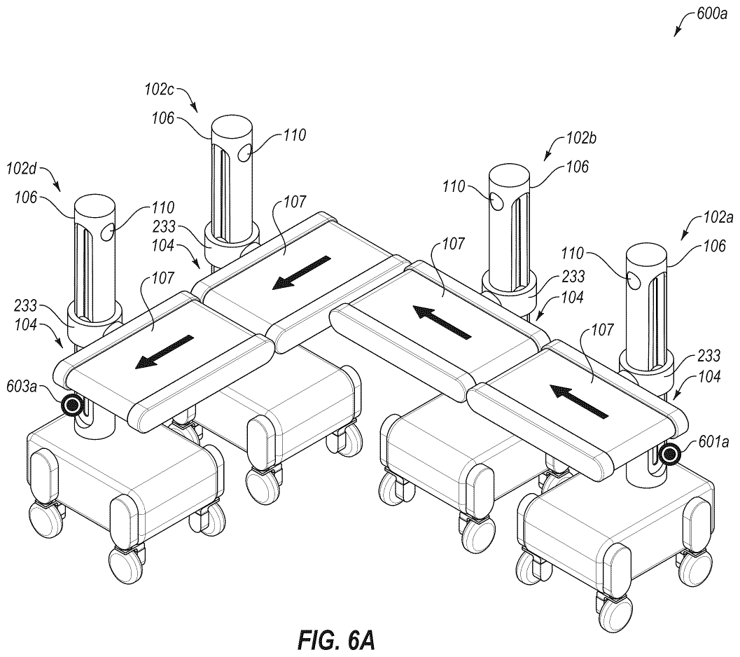

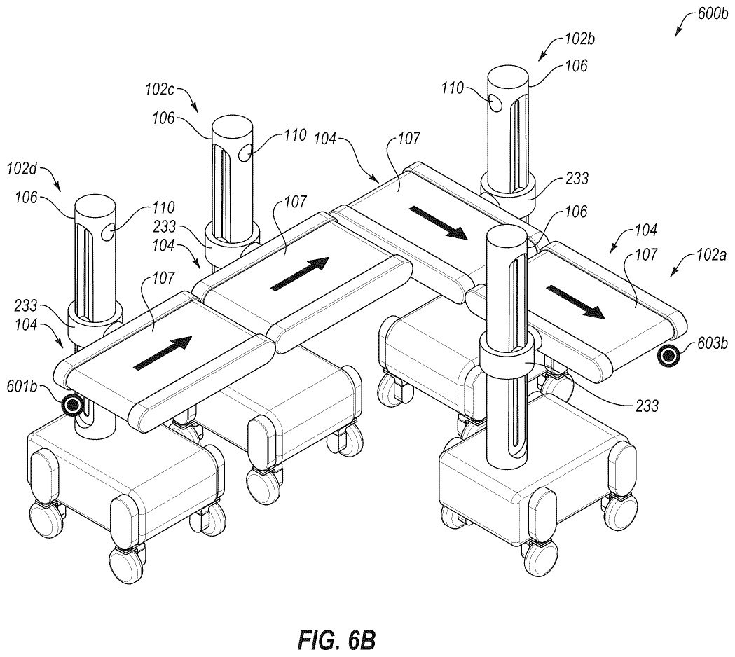

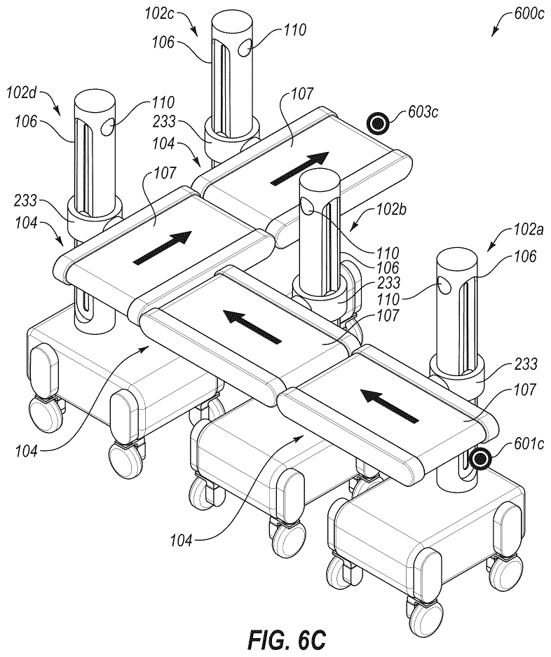

FIGS. 6A-6C illustrate example conveyor systems 600a-c that are formed by multiple instances of the robot 102a-d of FIG. 2, in accordance with at least one embodiment described in the present disclosure. The conveyor systems 600a-c may be configured to convey objects from start locations 601a-c to end locations 603a-c. The start locations 601a-c and/or the end locations 603a-c may include tables (e.g., the table 126 of FIG. 1), vehicles, external surfaces, shelves, bins (e.g., the bin 128 of FIG. 1), containers, other conveyor systems, or any other appropriate external device or surface. One or more of the robots 102a-d may correspond to the robots 122, 124 of FIG. 1.

With combined reference to FIGS. 1 and 6A-6C, the start locations 601a-c may correspond to the table 126 and the end locations 603a-c may correspond to the bin 128 or vice versa. The centralized device 120 may send instructions to the robots 102a-d (e.g., robots 102, 122, 124, or some combination thereof) to form one of the different conveyor systems 600a-c to convey the objects within the environment 100.

With combined reference to FIGS. 6A-6C, to form the conveyor systems 600a-c, the robots 102a-d may move to align themselves relative to each other and/or the start locations 601a-c and the end locations 603a-c to form paths. To convey objects from the start locations 601a-c to the end locations 603a-c, the belts 107 of the robots 102a-d may rotate in the clockwise direction, the counterclockwise direction, or both so that the objects may be conveyed in different directions.

As shown in FIG. 6A, the conveyor system 600a may be formed to convey objects from near a bottom right corner of the page to near a middle of a left side of the page. To form the conveyor system 600a, the robot 102a may align itself relative to the start location 601a to be able to receive objects. The robot 102b may align itself relative to the robot 102a to form a first part of the path between the start location 601a and the end location 603a.

The robot 102c may align itself relative to the robot 102b to form a transition between the first part of the path and a second part of the path. As shown in FIG. 6A, the first part of the path is moving from near the bottom right corner diagonally towards roughly a middle of the page towards and the second part of the path is moving from roughly the middle of the page towards the middle of the left side of the page. The robot 102d may align itself relative to the robot 102c and the end location 603a to complete the second part of the path.

The belt 107 of the robot 102a may rotate in the counterclockwise direction (e.g., direction 209 in FIG. 2) to receive objects from the start location 601a and convey the objects to the robot 102b. The belt 107 of the robot 102b may rotate in the counterclockwise direction to convey objects to the robot 102c. The belt 107 of the robot 102c may rotate in the counterclockwise direction to convey objects to the robot 102d. The belt 107 of the robot 102d may rotate in the counterclockwise direction to convey objects toward and offload objects to the end location 603a.

As shown in FIG. 6B, the conveyor system 600b may be formed to convey objects from near a bottom left corner of the page to near a middle of a right side of the page. To form the conveyor system 600b, the robot 102d may align itself relative to the start location 601b to be able to receive objects. The robot 102c may align itself relative to the robot 102d to form a first part of the path.

The robot 102b may align itself relative to the robot 102c to form a transition between the first part of the path and a second part of the path. As shown in FIG. 6B, the first part of the path is moving from near the bottom left corner diagonally towards roughly a middle of the page and the second part of the path is moving from roughly the middle of the page towards the middle of the right side of the page. The robot 102a may align itself relative to the robot 102b and the end location 603b to complete the second part of the path.

The belt 107 of the robot 102d may rotate in the clockwise direction (e.g., direction 207 of FIG. 2) to receive objects from the start location 601b and convey objects to the robot 102c. The belt 107 of the robot 102c may rotate in the clockwise direction to convey objects to the robot 102b. The belt 107 of the robot 102b may rotate in the clockwise direction to convey objects to the robot 102a. Because the robot 102a is facing an opposite direction as the robot 102b, the belt 107 of the robot 102a may rotate in the counterclockwise direction (e.g., direction 209 of FIG. 2) to convey objects toward and offload objects to the end location 603b. As shown in FIG. 6B, the belts 107 of each of the conveyors 104 may rotate independent of other belts 107 and/or the conveyor 104 of other robots 102a-d.

To transition from the conveyor system 600a shown in FIG. 6A to the conveyor system 600b shown in FIG. 6B, the robot 102b may move from a front side of the robot 102c to a left side of the robot 102c to connect the second part of the path to the first part of the path. In FIG. 6B, the robot 102a is shown as rotated one hundred eighty degrees from its position in FIG. 6B, for example purposes. The orientation of the robot 102a may remain the same as illustrated in FIG. 6A to form the conveyor system 600b of FIG. 6B.

As shown in FIG. 6C, the conveyor system 600c may be formed to convey objects from near a bottom right corner of the page to near a middle of a top edge of the page. To form the conveyor system 600c, the robot 102a may align itself relative to the start location 601c to receive objects. In addition, the robot 102b may align itself relative to the robot 102a to form a first part of the path.

The robot 102c may align itself relative to the robot 102b to form a transition between the first part of the path and a second part of the path. As shown in FIG. 6C, the first part of the path is moving from near the bottom right corner of the page towards roughly a middle of the page and the second part of the path is moving from roughly the middle of the page towards the middle of the top edge of the page. The robot 102d may align itself relative to the robot 102c and the end location 603c to complete the second part of the path.

The belt 107 of the robot 102a may rotate in the counterclockwise direction (e.g., direction 209 of FIG. 2) to receive objects from the start location 601c and convey objects toward the robot 102b. Additionally, the belt 107 of the robot 102b may rotate in the counterclockwise direction to convey objects toward the robot 102c. Further, the belt 107 of the robot 102c may rotate in the clockwise direction (e.g., direction 207 of FIG. 2) to convey objects toward the robot 102d and the end location 603a. The belt 107 of the robot 102d may rotate in the clockwise direction to convey objects toward and offload objects to the end location 603c.

To transition from the conveyor system 600a shown in FIG. 6A to the conveyor system 600c shown in FIG. 6C, the robots 102a-b may move to a front side of the robot 102d to connect the second part of the path to the first part of the path. Alternatively, to transition from the conveyor system 600a shown in FIG. 6A, to the conveyor system 600c shown in FIG. 6C, the robots 102c-d may move to a right side of the robot 102b to connect the second part of the path to the first part of the path. In addition, the drive motors of the robot 102c-d may transition to rotating in the clockwise direction (e.g., direction 207 in FIG. 2).

As shown in FIGS. 6A-6C, the robots 102a-d may move to position themselves in different configurations to convey objects from the start locations 601a-c to the end locations 603a-c while rotating the corresponding belts 107 in either direction. The start locations 601a-c and the end locations 603a-c are shown as examples and may be swapped. For example, the start location 601a and the end location 603a in FIG. 6A may be swapped and the belts 107 of the robots 102a-d may switch from rotating in the counterclockwise direction to rotating in the clockwise direction. As another example, the start location 601a and the end location 603a in FIG. 6A may be swapped and the belts 107 of the robots 102a-d may switch from rotating in the counterclockwise direction to rotating in the clockwise direction.

Multiple instances of the example robot 102 of FIG. 2 are shown in FIGS. 6A-6C for example purposes. The conveyor systems 600a-c may be formed by any appropriate number of instances of the example robot 102 shown in FIG. 2 or the example robot 102 shown in FIG. 3.

FIG. 7 illustrates an example computing system 700 that may be used by the robot 102 of FIG. 1. The computing system 700 may be configured to implement or direct one or more operations associated with operations of the robot 102 and/or the centralized device 120, which may include operation of the robot 102, the computing device 108, the centralized device 120, or some combination thereof. The computing system 700 may include a processor 702, a memory 704, a data storage 706, and a communication unit 708, which all may be communicatively coupled. The computing system 700 may be part of any of the systems or devices described in this disclosure.

The processor 702 may include any computing entity, or processing device including various computer hardware or software modules and may be configured to execute instructions stored on any applicable computer-readable storage media. For example, the processor 702 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 7, it is understood that the processor 702 may include any number of processors distributed across any number of networks or physical locations that are configured to perform individually or collectively any number of operations described herein.

The processor 702 may be configured to interpret and/or execute program instructions and/or process data stored in the memory 704, the data storage 706, or the memory 704 and the data storage 706. The processor 702 may fetch program instructions from the data storage 706 and load the program instructions in the memory 704. After the program instructions are loaded into memory 704, the processor 702 may execute the program instructions.

For example, the processor 702 may be configured to interpret and/or execute program instructions and/or process data stored in the memory 704, the data storage 706, or the memory 704 and the data storage 706. The program instruction and/or data may be related to an conveyor system such that the computing system 700 may perform or direct the performance of the operations associated therewith as directed by the instructions.

The memory 704 and the data storage 706 may include computer-readable storage media or one or more computer-readable storage mediums for carrying or having computer-executable instructions or data structures stored thereon. Such computer-readable storage media may be any available media that may be accessed by a computer, such as the processor 702.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 702 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500F.3d 1346 (Fed. Cir. 2007). Combinations of the above may also be included within the scope of computer-readable media.

The communication unit 708 may include any component, device, system, or combination thereof that is configured to transmit or receive information over a network. In some embodiments, the communication unit 708 may communicate with other devices at other locations, the same location, or even other components within the same system. For example, the communication unit 708 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 708 may permit data to be exchanged with a network and/or any other devices or systems described in the present disclosure.

Modifications, additions, or omissions may be made to the computing system 700 without departing from the scope of the present disclosure. For example, in some embodiments, the computing system 700 may include any number of other components that may not be explicitly illustrated or described. Further, depending on certain implementations, the computing system 700 may not include one or more of the components illustrated and described.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A robot comprising:
a support portion; and
a conveyor coupled to the support portion, wherein:
the conveyor comprises a belt configured to interface with an object to cause the object to be positioned on or positioned off the belt; and
the conveyor is configured to move along a height of the support portion to adjust a height of the belt relative to the support portion to permit the object to be positioned on or positioned off the belt at a variety of heights.

2. The robot of claim 1, wherein the conveyor comprises:
a frame coupled to the belt, the frame configured to maintain a shape of the belt; and
an interface portion coupled to the frame and the support portion, wherein the interface portion is configured permit the conveyor to move along the height of the support portion.

3. The robot of claim 1, wherein the conveyor is configured to rotate relative to an axis of the support portion to adjust an orientation of the belt relative to the support portion.

4. The robot of claim 3, wherein the conveyor is configured to rotate relative to the axis of the support portion to cause the conveyor to move between a default position and any position between ninety degrees and negative ninety degrees offset from the default position.

5. The robot of claim 1, wherein the conveyor is configured to rotate relative to an axis of the conveyor to adjust an angle of the belt relative to a ground surface.

6. The robot of claim 1, comprising arms coupled to the support portion, the arms configured to move along a height of the support portion to adjust a height of the arms relative to the conveyor to:
move the arms to a raised position to permit the object to be positioned on the belt;
move the arms to a lowered position to prevent the object from unintentionally falling off the belt; and
move the arms to the raised position to permit the object to be positioned off the belt.

7. The robot of claim 1, comprising arms coupled to the support portion, wherein the arms are configured to extend beyond an edge of the conveyor to permit the arms to interface with a container.

8. The robot of claim 1, wherein the conveyor is configured to:
receive the object and to position the object on the belt while the robot is moving; and
offload the object to a surface of another device while the robot is moving.

9. The robot of claim 1, wherein the robot is configured to move within an environment to position the robot relative to other robots to form a conveyor system.

10. The robot of claim 1, comprising arms coupled to the support portion, wherein the arms are configured to:
engage with a container; and
transfer the object between the container and the conveyor.

11. The robot of claim 1 comprising arms configured to perform at least one of:
position the object on the belt; or
sort items within the object while the object is positioned on the belt and the robot is moving within an environment.

12. A robot comprising:
a support portion;
arms coupled to the support portion; and
a conveyor comprising one or more attachment points configured to receive corresponding mating elements of the arms to couple the conveyor to the arms, the conveyor comprising an internal drive mechanism configured to, when the conveyor is attached to the arms, interface with an object to move the object along a length of the conveyor.

13. The robot of claim 12, wherein the arms are configured to extend beyond an edge of the conveyor to permit the arms to interface with a container while the conveyor is attached to the arms.

14. The robot of claim 12, wherein the arms are configured to rotate relative to an axis of the conveyor to adjust an angle of the conveyor relative to a ground surface.

15. The robot of claim 12, wherein the attachment points and the corresponding mating elements of the arms comprise at least one of a quick-release latch, a sliding rail interface, or a clamp mechanism.

16. The robot of claim 12, wherein:
the conveyor comprises a frame;
the frame comprises the attachment points to couple the conveyor to the arms; and
the arms are configured to move along a height of the support portion to adjust a height of the conveyor relative to the support portion to permit object to be positioned on or positioned off the conveyor at a variety of heights.

17. The robot of claim 12, wherein the arms are configured to rotate relative to an axis of the support portion to adjust an orientation of the conveyor relative to the support portion.

18. The robot of claim 12, wherein the conveyor is configured to detach from the arms to permit the arms to operate independently of the conveyor.

19. The robot of claim 11, wherein the conveyor is configured to:
receive the object and to position the object on the conveyor while the robot is moving; and
offload the object to a surface of another device while the robot is moving.

20. The robot of claim 12 comprising a sensor configured to capture sensor data representative of at least one of:
a position of the object relative to the conveyor;
a size of the object;
a dimension of the object;
a speed of the object relative to the conveyor;
a number of items within the object;
a label of the object;
a state of the object; or
a state of the conveyor.
